(19) United States
(12) Patent Application Publication
(10) Pub. No.: US 2014/0253885 A1
(43) Pub. Date: Sep. 11, 2014

(54) PROJECTION IMAGE DISPLAY DEVICE

(71) Applicant: Panasonic Corporation, Osaka (JP)

(72) Inventors: Yumeto NISHIYAMA, Osaka (JP); Mamoru NOMOTO, Osaka (JP); Masanori GOTOU, Osaka (JP); Tetsuya KANESHIRO, Osaka (JP); Ippei OHASHI, Osaka (JP)

(73) Assignee: Panasonic Corporation, Osaka (JP)

(21) Appl. No.: 14/197,084

(22) Filed: Mar. 4, 2014

(30) Foreign Application Priority Data
Mar. 7, 2013 (JP) 2013-044968
Dec. 25, 2013 (JP) 2013-267736

(51) Int. Cl. G03B 21/14

(52) U.S. Cl. CPC G03B 21/145
USPC 353/119

(57) ABSTRACT

A projection image display device 1 includes a housing 100, a projection lens 110, a front convex portion 50A and a rear convex portion 50B. The housing 100 accommodates an illumination optical system and a modulation optical system in an interior thereof. The projection lens 110 is configured to project an image modulated by the modulation optical system in a scaled-up size, and is disposed on a first lateral face 100b of the housing 100. The front convex portion 50A and the rear convex portion 50B are disposed on an intersection line between a plane containing an optical axis of the projection lens 110 and a top face 110a of the housing 100.

### CROSS-REFERENCE TO RELATED APPLICATIONS

This application claims priority to Japanese Patent Applications No. 2013-044968 filed on Mar. 7, 2013 and No. 2013-267736 filed on Dec. 25, 2013. The entire disclosures of Japanese Patent Applications No. 2013-044968 and No. 2013-267736 are hereby incorporated herein by reference.

### BACKGROUND

In recent years, a projection image display device has been increasingly used for purposes such as shows and events. Further, chances have been increased that a large number of projection image display devices project images onto a target such as a building, unlike a screen normally used so far.

Moreover, a large-sized projection image display device, which is capable of projecting an image onto a projection target located at a farther distance from the projection image display device, has been increasingly used with the trend of high-brightness projection image display devices.

However, an installation work of a projection image display device is mostly dependent on a guess of an installation worker in order to accurately project an image onto such a projection target (e.g., building) at a long distance.

Moreover, even when an outdoor installation of a projection image display device is performed in the daytime while projection is being performed by the projection image display device, it is difficult to perform the installation work while a projection image is being projected onto a projection target because of daytime brightness and the long distance to the projection target.

As a result, when projection is performed by a large number of projection image display devices prior to a show or event in the nighttime, the images projected from the projection image display devices are greatly displaced from the projection target. Hence, it is required to greatly modify the projection directions of the projection image display devices. Additionally, a drawback is produced that an effort for the installation work is inevitably increased by such a work for modifying installation positions in a dark surrounding environment.

In particular, when using a large-sized projection image display device for projecting an image onto a projection target located at a long distance from the projection image display device, chances are that once the large-sized projection image display device is temporarily installed, it becomes difficult to adjust the temporarily installed position. This is attributed to several reasons such as: that the large-sized projection image display device is heavier than a normal projection image display device, and the number of cables connected thereto is also greater than that of cables connected to a normal projection image device.

Further, Japanese Laid-open Patent Application Publication No. IP-A-2010-49007, for instance, discloses a projection image display device that knobs have been preliminarily attached to its housing in order to enhance workability in performing ceiling mount installation. However, the knobs do not contribute to enhancement of accuracy in projection direction in performing an installation work.

The present disclosure has been produced for solving the aforementioned drawback. It is an object of the present disclosure to provide a projection image display device whereby accuracy in projection direction in performing an installation work can be enhanced with a simple structure in a temporal installation phase prior to powering on the projection image display device.

### SUMMARY

A projection image display device according to the present disclosure includes a housing, a projection lens, and a marking. The housing accommodates an illumination optical system and a modulation optical system in an interior thereof. The projection lens is configured to project an image modulated by the modulation optical system in a scaled-up size, and is disposed on a first lateral face of the housing. At least one marking is disposed as an indicator for indicating a projection direction from the projection lens on an intersection line between a plane containing an optical axis of the projection lens and one of faces composing an exterior surface of the housing.

According to the projection image display device herein disclosed, it is possible to enhance accuracy in projection direction in performing a temporal installation work without causing the projection image device to perform projection.

### BRIEF DESCRIPTION OF THE DRAWINGS

Referring now to the attached drawings which form a part of this original disclosure:

FIG. 1 is a perspective view of a projection image display device according to a first exemplary embodiment of the present disclosure;

FIG. 2 is a front view of the projection image display device shown in FIG. 1;

FIG. 3 is a cross-sectional view of FIG. 2 cut along an arrow A-A′ without illustration of an internal mechanism;

FIG. 4 is a perspective view of a projection image display device according to a second exemplary embodiment of the present disclosure;

FIG. 5 is a front view of the projection image display device shown in FIG. 4;

FIG. 6 is a perspective view of a projection image display device according to a third exemplary embodiment of the present disclosure;

FIG. 7 is a front view of the projection image display device shown in FIG. 6;

FIG. 8 is a cross-sectional view of FIG. 7 cut along an arrow A-A′ without illustration of an internal mechanism;

FIG. 9 is a perspective view of a projection image display device according to a fourth exemplary embodiment of the present disclosure;

FIG. 10 is a front view of the projection image display device shown in FIG. 9;

FIG. 11 is a cross-sectional view of FIG. 10 cut along an arrow A-A′ without illustration of an internal mechanism;

FIG. 12 is a perspective view of a projection image display device according to a fifth exemplary embodiment of the present disclosure;

FIG. 13 is a front view of the projection image display device shown in FIG. 12;

FIG. 14 is a cross-sectional view of FIG. 13 cut along an arrow A-A′ without illustration of an internal mechanism; and

FIG. 15 is a perspective view of a projection image display device according to a sixth exemplary embodiment of the present disclosure.

### DETAILED DESCRIPTION

Exemplary embodiments will be hereinafter explained in detail with reference to the attached drawings on an as-needed basis. It should be noted that overly detailed explanation may not be hereinafter described. For example, detailed explanation of heretofore known facts and explanation of an element that is substantially the same as an already mentioned element may not be hereinafter described. This is intended to avoid unnecessary redundancy of the following explanation and allow a person skilled in the art to easily understand the following explanation.

It should be noted that the inventors of the present disclosure provide the attached drawings and the following explanation for allowing a person skilled in the art to sufficiently understand the present disclosure, and therefore, are not intended to limit the subject matter described in claims.

### First Exemplary Embodiment

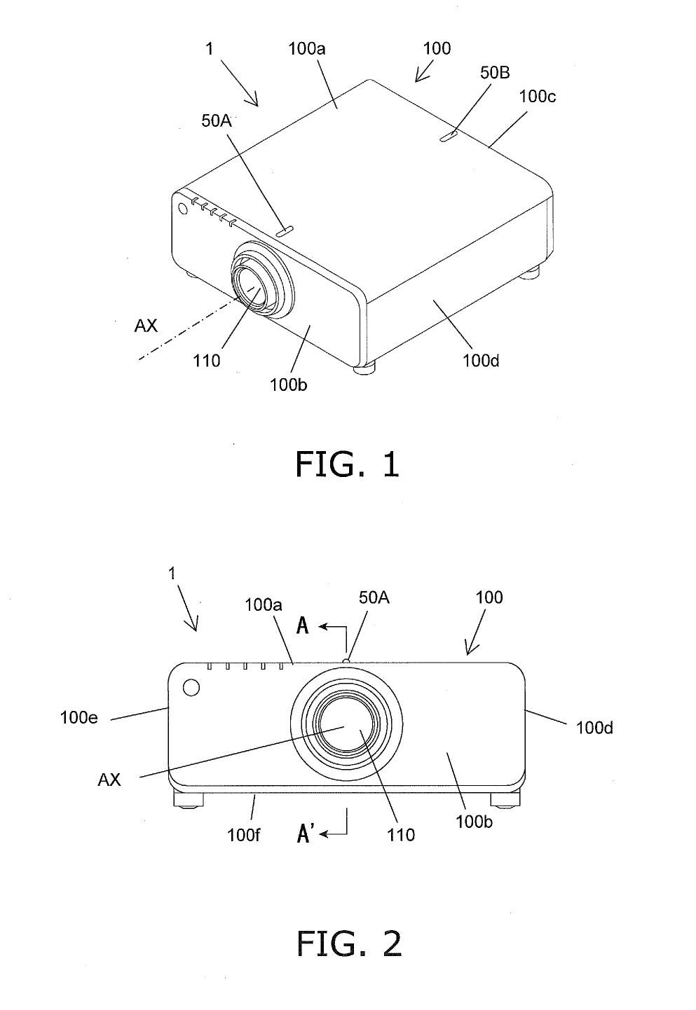

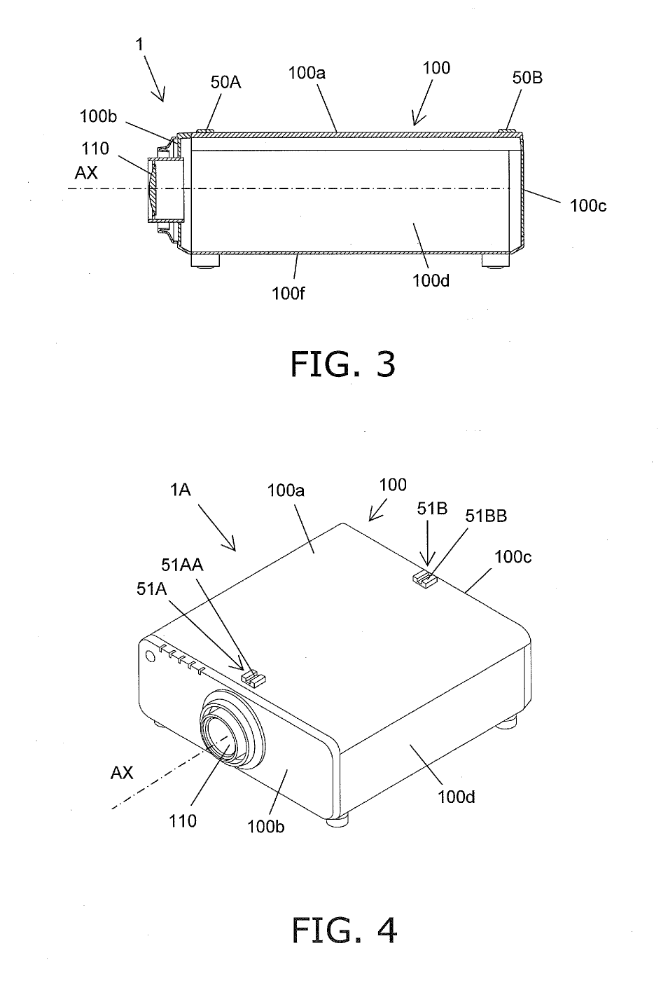

Using FIGS. 1 to 3, explanation will be hereinafter made for a first exemplary embodiment of the present disclosure.

A projection image display device 1 includes a housing 100 and a projection lens 110. The housing 100 is a component in which an illumination optical system and a modulation optical system (which are not shown in the drawings) are embedded. The projection lens 110 forms a part of a projection optical system for projecting an image modulated in the modulation optical system, and is exposed to the outside of the housing 100.

As shown in FIGS. 1 to 3, the housing 100 has a top face (exterior surface) 100a, a first lateral face 100b, a second lateral face 100c, a third lateral face 100d, a fourth lateral face 100e and a bottom face 100f.

The top face 100a is one of the two faces that have the largest area among the six faces composing the housing 100. The top face 100a is formed as an upper face of the housing 100, and has a roughly square shape in a plan view. Further, a front convex portion 50A and a rear convex portion 50B are formed on the top face 100a. The front convex portion 50A and the rear convex portion 50B are provided as markings to be used for pre-power-on temporal installation of the projection image display device 1.

The first lateral face 100b has an opening in its center part, and the projection lens 110 is fitted to the opening. The first lateral face 100b is formed as a front-side lateral face of the housing 100 in a usage position for irradiating light onto a projection target such as a large-sized screen or so forth.

The second lateral face 100c is a face opposed to the first lateral face 100b, and is formed as a rear-side lateral face of the housing 100 in the usage position.

The third lateral face 100d and the fourth lateral face 100e are faces opposed to each other, and are respectively formed as left and right lateral faces that connect the first lateral face 100b and the second lateral face 100c.

The bottom face 100f is a face opposed to the top face 100a, and members of the illumination optical system and the modulation optical system (not shown in the drawings) are attached to the top surface of the bottom face 100f.

The projection lens 110 is disposed so as to be exposed to the outside of the housing 100 in order to perform projection onto a projection target such as a large-sized screen. The projection lens 110 is also disposed in roughly the center part of the first lateral face 100b of the housing 100.

As shown in FIG. 2, the front convex portion 50A is formed on the top face 100a while being located immediately above the projection lens 110. The front convex portion 50A is also formed so as to be upwardly protruded from the top face 100a. More specifically, on the top face 100a, the front convex portion 50A is disposed on the first-lateral-face-100b side that the projection lens 110 is disposed, while being located in a position to minimize a distance between the top face 100a and an optical axis AX of the projection lens 110. In other words, the front convex portion 50A is disposed on the right-and-left directional center of the first-lateral-face-100b side part of the top face 100a, while being located immediately above the projection lens 110.

Similarly to the front convex portion 50A, the rear convex portion 50B is formed so as to be upwardly protruded from the top face 100a. Further as shown in FIG. 1, on the top face 100a, the rear convex portion 50B is disposed on the second-lateral-face-100c side, i.e., the opposite side of the first-lateral-face-100b side that the projection lens 110 is disposed, while being located on an intersection line between the top face 100a and a plane that contains the optical axis AX of the projection lens 110. In short, similarly to the front convex portion 50A, the rear convex portion 50B is disposed on the right-and-left directional center of the second-lateral-face-100c side part of the top face 100a.

Moreover, the front convex portion 50A and the rear convex portion 50B are provided as indicators for indicating a direction of projection from the projection lens 110, and are integrally formed with the top face 100a. Therefore, in molding the top face 100a with resin or so forth, the front convex portion 50A and the rear convex portion 50B can be integrally molded.

In the projection image display device 1 of the present exemplary embodiment, the front convex portion 50A and the rear convex portion 50B are herein disposed in predetermined positions on the top face 100a composing a part of the housing 100.

The front convex portion 50A and the rear convex portion 50B are provided as markings for performing alignment of the projection image display device 1 in the pre-power-on temporal installation phase of the installation of the projection image display device 1.

Specifically, when performing alignment in the temporal installation phase, a user moves to the same side as the second lateral face 100c of the housing 100, and performs alignment of the projection image display device 1 from the second-lateral-face-100c side such that a direction connecting the rear convex portion 50B and the front convex portion 50A and a roughly center position of a projection target such as a large-sized screen are overlapped with each other.

Accordingly, the optical axis AX of the projection lens 110 of the projection image display device 1 and the center of the projection target can be roughly matched with each other easily without powering on the projection image display device 1 and without causing it to perform projection. Therefore, accuracy in projection direction can be enhanced even in temporarily installing the large-sized heavy projection image display device 1 to which a large number of cables are connected.

### Second Exemplary Embodiment

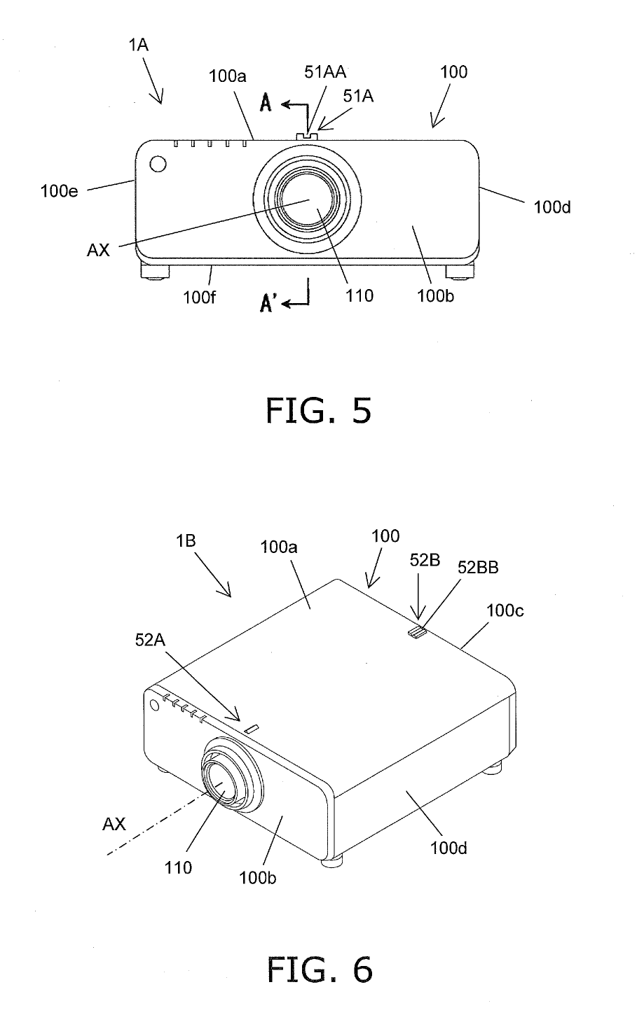

Using FIGS. 4 and 5, explanation will be made for a second exemplary embodiment of the present disclosure.

It should be noted that, when components herein have the same functions as corresponding ones explained in the first exemplary embodiment, reference signs assigned to the corresponding ones will be also assigned to the components of the present exemplary embodiment, and explanation thereof will not be hereinafter made.

As shown in FIG. 4, in a projection image display device 1A of the present exemplary embodiment, a front protruded portion 51A and a rear protruded portion 51B are disposed on the top face 100a composing a part of the housing 100 instead of the front convex portion 50A and the rear convex portion 50B. In this regard, the projection image display device 1A of the present exemplary embodiment is different from the aforementioned projection image display device 1 of the first exemplary embodiment.

As shown in FIG. 5, the front protruded portion 51A is formed on the top face 100a while being located immediately above the projection lens 110. The front protruded portion 51A is formed as a concave member upwardly protruded from the top face 100a. More specifically, on the top face 100a, the front protruded portion 51A is disposed on the first-lateral-face-100b side that the projection lens 110 is disposed, while being located in a position to minimize a distance between the top face 100a and the optical axis AX of the projection lens 110. In other words, the front protruded portion 51A is disposed on the right-and-left directional center of the first-lateral-face-100b side part of the top face 100a, while being located immediately above the projection lens 110.

Similarly to the front protruded portion 51A, the rear protruded portion 51B is formed as a concave member upwardly protruded from the top face 100a. Further as shown in FIG. 4, on the top face 100a, the rear protruded portion 51B is disposed on the second-lateral-face-100c side, i.e., the opposite side of the first-lateral-face-100b side that the projection lens 110 is disposed, while being located on an intersection line between the top face 100a and a plane that contains the optical axis AX of the projection lens 110. In short, similarly to the front protruded portion 51A, the rear protruded portion 51B is disposed on the right-and-left directional center of the second-lateral-face-100c side part of the top face 100a.

Moreover, the front protruded portion 51A and the rear protruded portion 51B are provided as indicators for indicating a direction of projection from the projection lens 110, and are integrally formed with the top face 100a. Therefore, in molding the top face 100a with resin or so forth, the front protruded portion 51A and the rear protruded portion 51B can be integrally molded.

In the present exemplary embodiment, the front protruded portion 51A and the rear protruded portion 51B, formed on the top face 100a as markings to be used in temporarily installing the projection image display device 1A, herein respectively have concave shapes. Therefore, a hollow 51AA, 51BB is formed between two protruded portions of each concave shape.

Accordingly, when performing alignment in the temporal installation phase, a user moves to the same side as the second lateral face 100c of the housing 100, and performs alignment of the projection image display device 1A from the second-lateral-face-100c side such that a direction, in which the hollow 51BB of the rear protruded portion 51B and the hollow 51AA of the front protruded portion 51A are overlapped, and the roughly center position of a projection target are overlapped with each other.

As a result, the optical axis AX of the projection lens 110 of the projection image display device 1A and the center of the projection target can be roughly matched with each other easily without powering on the projection image display device 1A and without causing it to perform projection. Therefore, accuracy in projection direction can be enhanced even in temporarily installing the large-sized heavy projection image display device 1A to which a large number of cables are connected.

### Third Exemplary Embodiment

Using FIGS. 6 and 8, explanation will be made for a third exemplary embodiment of the present disclosure.

It should be noted that, when components herein have the same functions as corresponding ones explained in the first and second exemplary embodiments, reference signs assigned to the corresponding ones will be also assigned to the components of the present exemplary embodiment, and explanation thereof will not be hereinafter made.

As shown in FIG. 6, in a projection image display device 1B of the present exemplary embodiment, a front protrusion 52A and a rear protrusion 52B are disposed as markings on the top face 100a composing a part of the housing 100. In this regard, the projection image display device 1B of the present exemplary embodiment is different from the aforementioned projection image display devices 1 and 1A of the first and second exemplary embodiments.

In other words, the front protrusion 52A of the present exemplary embodiment has a shape similarly to that of the aforementioned front convex portion 50A of the first exemplary embodiment, whereas the rear protrusion 52B of the present exemplary embodiment has a shape similar to that of the aforementioned rear protruded portion 51B of the second exemplary embodiment.

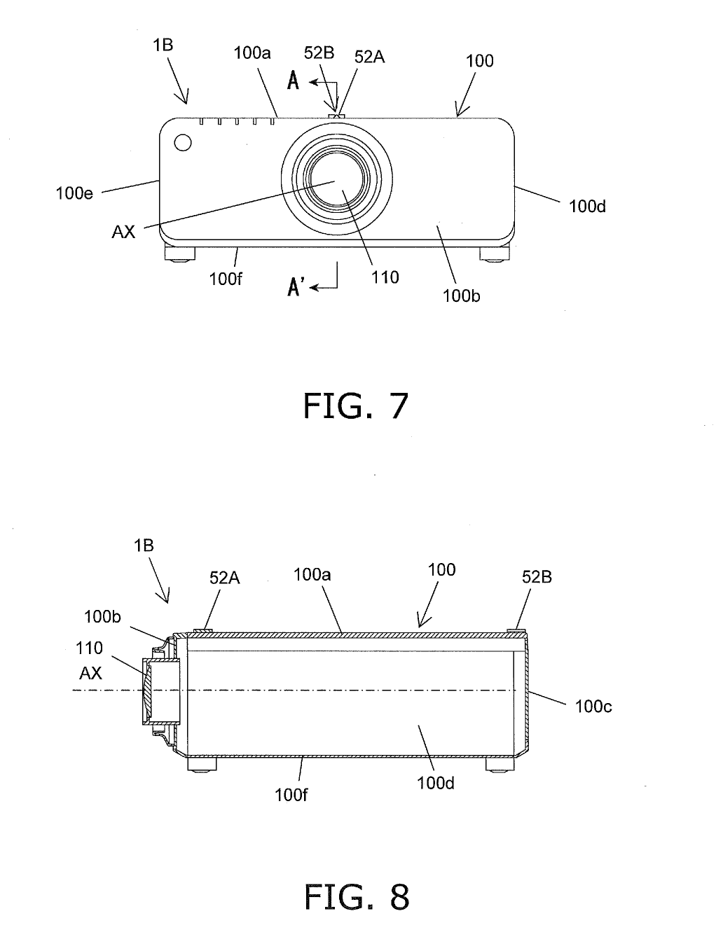

As shown in FIG. 7, the front protrusion 52A is formed on the top face 100a while being located immediately above the projection lens 110. The front protrusion 52A is also formed so as to be upwardly protruded from the top face 100a. More specifically, on the top face 100a, the front protrusion 52A is disposed on the first-lateral-face-100b side that the projection lens 110 is disposed, while being located in a position to minimize a distance between the top face 100a and the optical axis AX of the projection lens 110. In other words, the front protrusion 52A is disposed on the right-and-left directional center of the first-lateral-face-100b side part of the top face 100a, while being located immediately above the projection lens 110.

The rear protrusion 52B is formed as a concave member upwardly protruded from the top face 100a. Further as shown in FIG. 6, on the top face 100a, the rear protrusion 52B is disposed on the second-lateral-face-100c side, i.e., the opposite side of the first-lateral-face-100b side that the projection lens 110 is disposed, while being located on an intersection line between the top face 100a and a plane that contains the optical axis AX of the projection lens 110. In short, similarly to the front protrusion 52A, the rear protrusion 52B is disposed on the right-and-left directional center of the second-lateral-face-100c side part of the top face 100a.

Moreover, the front protrusion 52A and the rear protrusion 52B are provided as indicators for indicating a direction of projection from the projection lens 110, and are integrally formed with the top face 100a. Therefore, in molding the top face 100a with resin or so forth, the front protrusion 52A and the rear protrusion 52B can be integrally molded.

In the present exemplary embodiment, the front protrusion 52A and the concave-shaped rear protrusion 52B are formed on the top face 100a as markings to be used in temporarily installing the projection image display device 1B. Therefore, a hollow 52BB is formed between two protruded portions of the concave-shaped rear protrusion 52B.

Accordingly, when performing alignment in the temporal installation phase, a user moves to the same side as the second lateral face 100c of the housing 100, and performs alignment of the projection image display device 1B from the second-lateral-face-100c side such that a direction, in which the hollow 52BB of the rear protrusion 52B and the front protrusion 52A are overlapped, and the roughly center position of a projection target are roughly matched with each other.

As a result, the optical axis AX of the projection lens 110 of the projection image display device 1B and the center of the projection target can be roughly matched with each other easily without powering on the projection image display device 1B and without causing it to perform projection. Therefore, accuracy in projection direction can be enhanced even in temporarily installing the large-sized heavy projection image display device 1B to which a large number of cables are connected.

### Fourth Exemplary Embodiment

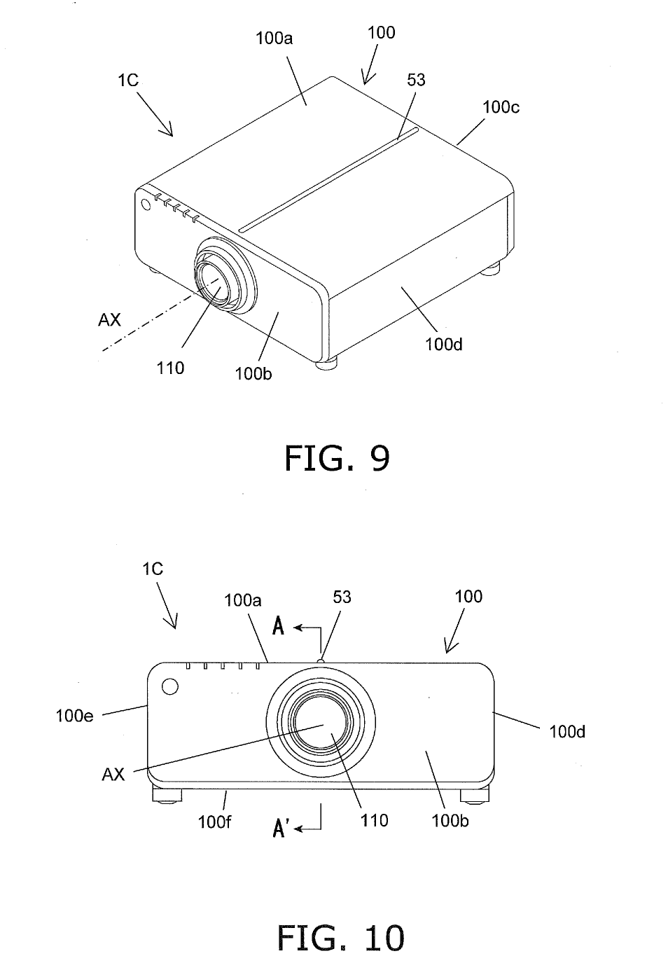

Using FIGS. 9 to 11, explanation will be made for a fourth exemplary embodiment of the present disclosure.

It should be noted that, when components herein have the same functions as corresponding ones explained in the first to third exemplary embodiments, reference signs assigned to the corresponding ones will be also assigned to the components of the present exemplary embodiment, and explanation thereof will not be hereinafter made.

As shown in FIG. 9, in a projection image display device 1C of the present exemplary embodiment, a ridge 53 is provided as a marking formed on the top face 100a composing a part of the housing 100. In this regard, the projection image display device 1C of the present exemplary embodiment is different from the aforementioned projection image display devices 1, 1A and 1B of the first to third exemplary embodiments.

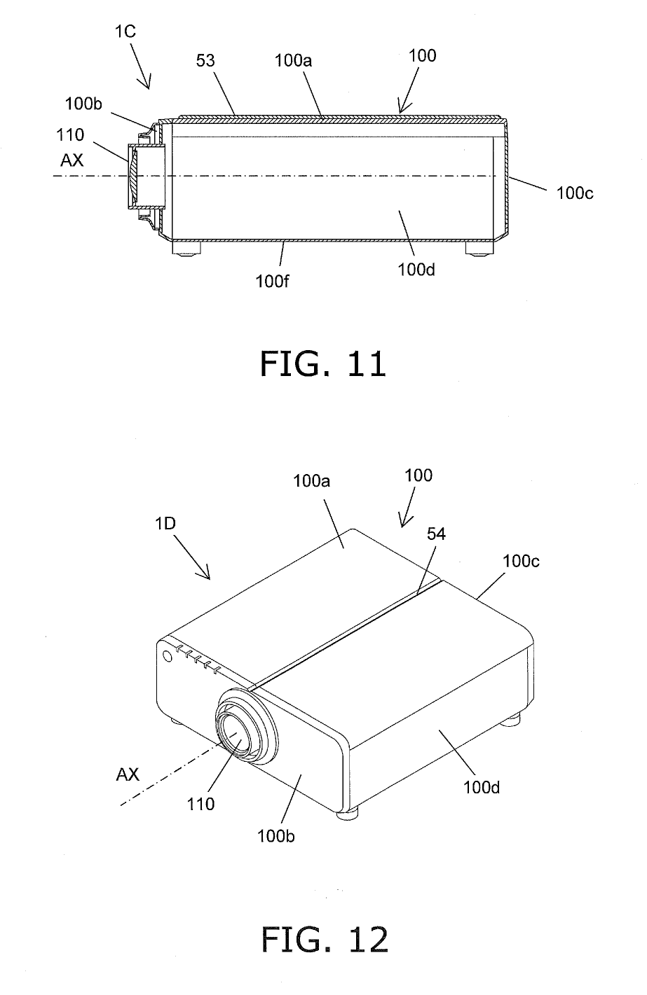

As shown in FIG. 10, as an indicator for indicating a direction of projection from the projection lens 110, the ridge 53 is formed on the top face 100a while being located immediately above the projection lens 110. The ridge 53 is also formed so as to be upwardly protruded from the top face 100a. More specifically, the ridge 53 is disposed on the top face 100a along a line that is arranged in parallel to the optical axis AX of the projection lens 110 and passes through a position to minimize a distance between the top face 100a and the optical axis AX. In other words, as shown in FIGS. 9 and 11, the ridge 53 is disposed on the top face 100a so as to be extended from the first-lateral-face-100b side to the second-lateral-face-100c side, while being located immediately above the projection lens 110. Further, the ridge 53 is integrally formed with the top face 100a of the housing 100. Accordingly, in molding the top face 100a with resin or so forth, the ridge 53 can be integrally molded therewith.

In the present exemplary embodiment, the ridge 53, extended from the first-lateral-face-100b side to the second-lateral-face-100c side, is herein formed as a marking to be used in temporarily installing the projection image display device 1C.

Accordingly, when performing alignment in the temporal installation phase, a user moves to the same side as the second lateral face 100c of the housing 100, and performs alignment of the projection image display device 1C from the second-lateral-face-100c side such that the tip end position of the ridge 53 is overlapped with roughly the center of a projection target along the extended direction of the ridge 53.

As a result, the optical axis AX of the projection lens 110 of the projection image display device 1C and the center of the projection target can be roughly matched with each other easily without powering on the projection image display device 1C and without causing it to perform projection. Therefore, accuracy in projection direction can be enhanced even in temporarily installing the large-sized heavy projection image display device 1C to which a large number of cables are connected.

### Fifth Exemplary Embodiment

Using FIGS. 12 to 14, explanation will be made for a fifth exemplary embodiment of the present disclosure.

It should be noted that, when components herein have the same functions as corresponding ones explained in the first to fourth exemplary embodiments, reference signs assigned to the corresponding ones will be also assigned to the components of the present exemplary embodiment, and explanation thereof will not be hereinafter made.

As shown in FIG. 12, in a projection image display device 1D of the present exemplary embodiment, a groove (marking, mount portion) 54 is provided as a marking formed on the top face 100a composing a part of the housing 100. In this regard, the projection image display device 1D of the present exemplary embodiment is different from the aforementioned projection image display devices 1, 1A, 1B and 1C of the first to fourth exemplary embodiments.

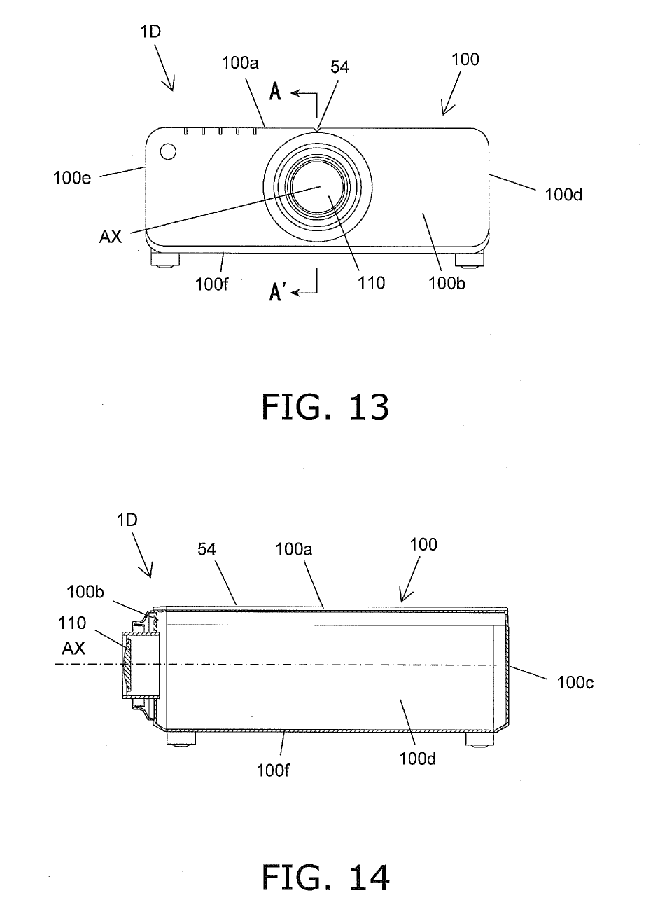

As shown in FIG. 13, as an indicator for indicating a direction of projection from the projection lens 110, the groove 54 is formed on the top face 100a while being located immediately above the projection lens 110. The groove 54 is formed by partially denting the top face 100a. More specifically, the groove 54 is disposed on the top face 100a along a line that is arranged in parallel to the optical axis AX of the projection lens 110 and passes through a position to minimize a distance between the top face 100a and the optical axis AX. In other words, as shown in FIG. 14, the groove 54 is disposed on the top face 100a so as to be extended from the first-lateral-face-100b side to the second-lateral-face-100c side, while being located immediately above the projection lens 110. Further, the groove 54 is integrally formed with the top face 100a of the housing 100. Accordingly, in molding the top face 100a with resin or so forth, the groove 54 can be integrally molded therewith.

In the present exemplary embodiment, the groove 54, extended from the first-lateral-face-100b side to the second-lateral face-100c side, is herein formed as a marking to be used in temporarily installing the projection image display device 1D.

Accordingly, when performing alignment in the temporal installation phase, a user moves to the same side as the second lateral face 100c of the housing 100, and performs alignment of the projection image display device 1D from the second-lateral-face-100c side such that the tip end position of the groove 54 is overlapped with roughly the center of a projection target along the extended direction of the groove 54.

As a result, the optical axis AX of the projection lens 110 of the projection image display device 1D and the center of the projection target can be roughly matched with each other easily without powering on the projection image display device 1D and without causing it to perform projection. Therefore, accuracy in projection direction can be enhanced even in temporarily installing the large-sized heavy projection image display device 1D to which a large number of cables are connected.

### Sixth Exemplary Embodiment

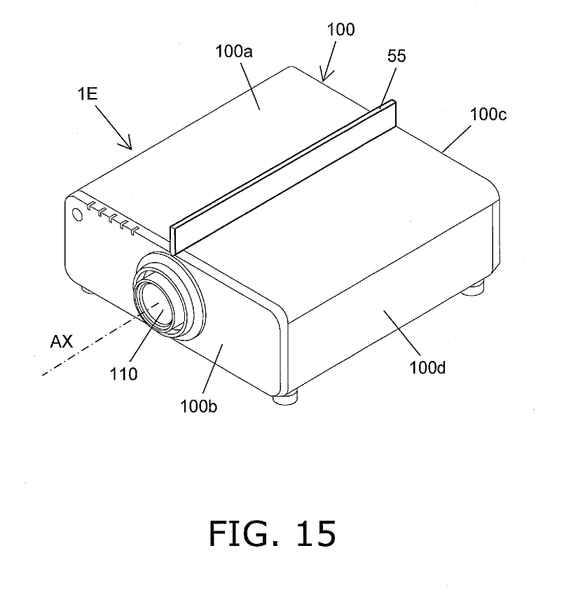

Using FIG. 15, explanation will be made for a sixth exemplary embodiment of the present disclosure.

It should be noted that, when components herein have the same functions as corresponding ones explained in the first to fifth exemplary embodiments, reference signs assigned to the corresponding ones will be also assigned to the components of the present exemplary embodiment, and explanation thereof will not be hereinafter made.

As shown in FIG. 15, in a projection image display device 1E of the present exemplary embodiment, a ruler 55 is provided as a marking formed on the top face 100a composing a part of the housing 100. The ruler 55 has a rectangular shape, and is mounted as an auxiliary marking to the hollow 51AA of the concave front protruded portion 51A and the hollow 51BB of the concave rear protruded portion 51B in the second exemplary embodiment. In this regard, the projection image display device 1E of the present exemplary embodiment is different from the aforementioned projection image display devices 1, 1A, 1B, 1C and 1D of the first to fifth exemplary embodiments.

It should be noted that the groove 54 of the fifth exemplary embodiment may be set as the portion to which the ruler 55 is mounted.

Thus, when installing the projection image display device 1E that the ruler 55 is attached to the top face 100a composing a part of the housing 100, a user moves to the same side as the second lateral face 100c, and performs alignment of the projection image display device 1E such that the tip end position of the ruler 55 is overlapped with roughly the center of a projection target along the longitudinal direction of the ruler 55.

The ruler 55 is herein used as an auxiliary marking, and can be utilized as a larger-sized marking.

Thus, the optical axis AX of the projection lens 110 of the projection image display device 1E and the center (especially, the center in the horizontal direction) of the projection target can be roughly matched with each other more easily and without powering on the projection image display device 1E and without causing it to perform projection. As a result, accuracy in projection direction can be enhanced even in temporarily installing the large-sized heavy projection image display device 1E to which a large number of cables are connected.

As described above, the exemplary embodiments have been explained as examples of the technology disclosed in the present application. However, the technology in the present disclosure is not limited to the aforementioned exemplary embodiments, and is also applicable to those for which changing, replacement, addition, exclusion and so forth have been performed on an as-needed basis.

Further as described above, the exemplary embodiments have been explained as examples of the technology of the present disclosure. In accordance, the attached drawings and the detailed description have been provided.

Therefore, composing elements, shown in the attached drawings and described in the detailed description, can include elements unessential to solve the technical problem as well as elements essential to solve the technical problem for the purpose of exemplifying the aforementioned technology. Thus, it should not be immediately assumed that such unessential elements are indispensable to solve the technical problem just because they are shown in the attached drawings and described in the detailed description.

### Other Exemplary Embodiments

The exemplary embodiments of the present disclosure have been explained above. However, the aforementioned exemplary embodiments are intended to exemplify the technology of the present disclosure. Therefore, changing, replacement, addition, exclusion and so forth can be variously made within the scope of the appended claims or the equivalents thereof.

(A)

Some of the aforementioned exemplary embodiments have been explained by exemplifying the structure that the marking (e.g., the front convex portion 50A and the rear convex portion 50B) is disposed on the top face 100a of the housing 100 so as to be located in the position to minimize the distance between the top face 100a and the optical axis AX of the projection lens 110, i.e., in the position immediately above the projection lens 110. However, the present disclosure is not limited to the structure.

For example, the marking is not limited to be located immediately above the projection lens. Alternatively, the marking may be located in a position displaced either right or left from the position immediately above the projection lens.

(B)

One of the aforementioned exemplary embodiments has been explained by exemplifying the ruler 55 as an auxiliary marking. However, the present disclosure is not limited to the configuration.

For example, a laser pointer may be used as an auxiliary marking.

In this case, for instance, it is only required to mount the laser point to the groove 54 shown in FIG. 13 and cause the laser pointer to irradiate light in order to perform alignment with respect to a projection target.

Accordingly, in comparison with a well-known structure, more accurate alignment can be performed in the pre-power-on temporal installation phase of the projection image display device.

(C)

Some of the aforementioned exemplary embodiments have been explained by exemplifying the structures that the front and rear convex portions 50A and 50B, the front and rear protruded portions 51A and 51B, the front and rear protrusions 52A and 52B, and the ridge 53, for instance, are integrally formed with the housing 100, respectively. However, the present disclosure is not limited to the structures.

For example, advantageous effects similar to those achieved by the aforementioned structures can be also achieved even with the structure that elements, formed separately from each other, are integrated to the housing 100 by means of an arbitrary adhesion method such as welding or bonding.

(D)

Some of the aforementioned exemplary embodiments have been explained by exemplifying the structures that the front and rear convex portions 50A and 50B, the front and rear protruded portions 51A and 51B, the front and rear protrusions 52A and 52B, the ridge 53, and the groove 54 are respectively disposed on the upper face of the housing 100 installed on the floor. However, the present disclosure is not limited to the structures.

For example, the marking/markings may be disposed on the bottom face in ceiling mount installation. On the other hand, the marking/markings may be disposed on a lateral face upwardly directed in wall mount installation. In short, it is only required for the marking/markings to be disposed on an upwardly directed face of the housing depending on the installation conditions of the projection image display device.

(E)

In some of the aforementioned exemplary embodiments, portions formed as the front and rear convex portions 50A and 50B, the front and rear protruded portions 51A and 51B, the front and rear protrusions 52A and 52B, the ridge 53, and the groove 54 may be made of, for instance, a luminous material or a fluorescent material.

Alternatively, structures may be employed that a luminous material or a fluorescent material is applied to the front and rear convex portions 50A and 50B, the front and rear protruded portions 51A and 51B, the front and rear protrusions 52A and 52B, the ridge 53, and the groove 54, respectively.

With the structure, the marking/markings can be clearly recognized even in the evening or in a dusky room.

(F)

Some of the aforementioned exemplary embodiments have been explained by exemplifying: the structures that the front and rear convex portions 50A and 50B, the front and rear protruded portions 51A and 51B, and the front and rear protrusions 52A and 52B are respectively disposed on the first-lateral-face-100b side and the second-lateral-face-100c side on the top face 100a of the housing 100; or the structures that the ridge 53 and the groove 54 are respectively disposed so as to be extended from the first-lateral-face-100b side to the second-lateral-face-100c side on the top face 100a. However, the present disclosure is not limited to the structures.

For example, a structure may be employed that a single triangle marking is disposed on one of the faces composing the exterior surface of the housing.

In this case, the triangle marking is disposed on the second-lateral face side, and alignment is performed such that in a view seen from the bottom side of the triangle marking, a projection target is disposed on an extended line from a straight line segment connecting the center of the bottom side and the apex opposed to the bottom side in the triangle marking. Accordingly, temporal alignment of the projection image display device can be implemented.

Further, in the structure that a single marking is disposed on one of the faces composing the exterior surface of the housing, alignment of the projection image display device may be performed by combining a part of the outer contour of the projection image display device with the single marking.

For example, when having a structure that a lens barrel of the projection lens is protruded to the outside of the housing, alignment is performed such that in a view seen from the second-lateral-face side, a projection target is disposed on an extended line from a straight line segment connecting the marking and the apex portion of the lens barrel. Accordingly, temporal alignment of the projection image display device can be implemented.

It should be noted that the shape of the marking is not limited to triangle as described above.

### GENERAL INTERPRETATION OF TERMS

In understanding the scope of the present invention, the term “configured” as used herein to describe a component, section, or part of a device includes hardware and/or software that is constructed and/or programmed to carry out the desired function.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts.

Terms that are expressed as “means-plus function” in the claims should include any structure that can be utilized to carry out the function of that part of the present invention. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A projection image display device, comprising:
a housing including an interior and a plurality faces, each face including an exterior surface of the housing;
an illumination optical system disposed in the interior of the housing;
a modulation optical system disposed in the interior of the housing;
a projection lens including an optical axis,
the projection lens configured to project an image in a projection direction in a scaled-up size,
the projection lens disposed on a first lateral face of the housing,
the modulation optical system configured to modulate the image;
a plane including the optical axis of the projection lens;
an intersection line, the intersection line disposed at the intersection of the plane and a face of the housing; and
at least one marking disposed on an exterior surface of the housing on the intersection line;
wherein the at least one marking indicates the projection direction.

2. The projection image display device according to claim 1, wherein:
the number of markings disposed on the intersection line is at least two.

3. The projection image display device according to claim 1, further including:
a first lateral face disposed on an exterior surface of the housing upon which the projection lens is disposed; and
a second lateral face disposed on an exterior surface of the housing opposing the first lateral face;
wherein the at least one marking is disposed at least on the first lateral face, and at least one marking is disposed on the second lateral face.

4. The projection image display device according to claim 1, wherein:
the intersection line is arranged such that it minimizes a distance between the at least one marking and the optical axis.

5. The projection image display device according to claim 1, further including:
a plurality of protruded portions disposed at a predetermined interval about the intersection line;
wherein the at least one marking includes a groove portion formed between the protruded portions, and the groove is disposed along the intersection line between the protruded portions.

6. The projection image display device according to claim 3, wherein:
the at least one marking is extends from the first lateral face to the second lateral face.

7. The projection image display device according to claim 5, wherein:
the at least one marking includes a mount portion to which an auxiliary marking can be mounted, and the auxiliary marking is configured to assist alignment of the image display device.

8. The projection image display device according to claim 1, wherein:
the marking has been processed with a fluorescence process.

9. The projection image display device according to claim 1, wherein:
the intersection line is disposed on a top face of the housing.

10. The projection image display device according to claim 3, wherein:
the projection lens is disposed on a middle part of the first lateral face.
